(19) United States
(12) Patent Application Publication
(10) Pub. No.: US 2014/0323383 A1
(43) Pub. Date: Oct. 30, 2014

(54) POUCH COMPRISING A LIQUID DETERGENT COMPOSITION

(71) Applicant: The Procter & Gamble Company, Cincinnati, OH (US)

(72) Inventors: Rafael TRUJILLO, Mason, OH (US); Jean-Francois BODET, Waterloo (BE); Jean - Pol BOUTIQUE, Gembloux (BE); Giulia Ottavia BIANCHETTI, Roma (IT); Jef MAES, Sint-Niklaas (BE); Jarno Johan Chris HUYGH, Strijtem (BE)

(73) Assignee: The Procter & Gamble Company, Cincinnati, OH (US)

(21) Appl. No.: 14/217,849

(22) Filed: Mar. 18, 2014

Related U.S. Application Data
(60) Provisional application No. 61/816,164, filed on Apr. 26, 2013.

(51) Int. Cl. C11D 17/00

(52) U.S. Cl. CPC C11D 17/0039
USPC 510/439

(57) ABSTRACT

A pouch comprising a water-soluble film and a liquid detergent composition contained within the water-soluble film. The liquid detergent composition comprising: a) an alkanolamine; b) a sulfite; c) a perfume oil comprising aldehyde or ketone; and d) a sulfur-containing pro-perfume compound, delivers improved stability and perfume longevity.

### FIELD OF THE INVENTION

The present invention relates to a pouch comprising a water-soluble film and a liquid detergent composition contained within the water-soluble film.

### BACKGROUND OF THE INVENTION

Consumer products may comprise one or more perfume oils and/or perfume delivery systems that provide a desired scent to such a product and/or a situs treated with such a product. While current perfume oils and perfume delivery systems provide desirable scents, users continue to seek products that have improved perfume longevity, i.e., a prolonged retention of the character and intensity of the perfume, either when incorporated in a detergent composition or deposited onto a situs (e.g., treated fabrics). During the past years, perfume delivery systems have evolved to address user needs for the improved perfume longevity, while perfume oils are more proper for providing immediate scents.

In the context of liquid detergent compositions or pouches comprising such compositions, the incorporation of perfume oils or perfume delivery systems leads to a formulation stability issue. Specifically, aldehydes or ketones that are commonly contained in a perfume oil would react with primary amines (e.g. an alkanolamine) conventionally used as a neutralizer in a liquid detergent composition via a Schiff-base reaction. The Schiff-base reaction can adversely affect both the perfume and the alkanolamine, thereby causing a color change of the composition. In order to prevent the Schiff-base reaction, sulfites are known to be used. Without wishing to be bound by theory, the sulfite competitively binds with the aldehydes or ketones, thus preventing the aldehydes or ketones from reacting with the alkanolamine. However, the incorporation of sulfites in a liquid detergent composition requires a careful selection of perfume delivery systems.

Thus, there is a need for a pouch comprising a stable liquid detergent composition that provides improved perfume longevity but that minimizes the level of sulfite (to preserve perfume character and intensity). Specifically, the present invention provides a pouch comprising a stable liquid detergent composition that comprises an alkanolamine, a sulfite, a perfume oil comprising aldehyde or ketone, and a perfume delivery system, whilst delivering improved perfume longevity.

It is an advantage of the present invention to provide a pouch comprising a liquid detergent composition that does not discolor over time.

It is another advantage of the present invention to provide a pouch comprising a liquid detergent composition that provides appealing aesthetics over time.

### SUMMARY OF THE INVENTION

In one aspect, the present invention is directed to a pouch, comprising a water-soluble film and a liquid detergent composition contained within the water-soluble pouch, wherein the liquid detergent composition comprises: a) an aklanolamine; b) a sulfite; c) a perfume oil comprising aldehyde or ketone; and d) a sulfur-containing pro-perfume compound.

The sulfite functions to prevent the Schiff-base reaction between the alkanolamine and the perfume oil comprising aldehyde or ketone, which would otherwise result in discoloration of the composition. However, the incorporation of the sulfite requires a careful selection of perfume delivery systems. For example, an amine-assisted perfume delivery system (AAD) comprising a polymeric amine and perfume raw materials (PRMs), may release additional aldehydes or ketones that will react with the sulfite, i.e., consuming the sulfite that was intended to prevent the Schiff-base reaction. Accordingly, in the present invention, applicant has surprisingly found that in such a context of liquid detergent composition, namely, a liquid detergent composition comprising the alkanolamine; the sulfite; and the perfume oil comprising aldehyde or ketone, the incorporation of the sulfur-containing pro-perfume compound into the composition delivers improved perfume longevity versus other types of perfume delivery systems (e.g., AAD), without causing a stability issue.

Without wishing to be bound by theory, it is believed that in the sulfur-containing pro-perfume compound, the perfume raw materials (PRMs), e.g., delta-damascone, are covalently bonded with other chemical structures, therefore not being available to react with the sulfite. The function of preventing the Schiff-base reaction by the sulfite is not affected while preserving the character and intensity of the perfume. In conclusion, a pouch comprising a stable liquid detergent composition having improved perfume longevity is achieved.

In another aspect, the present invention is directed to a liquid detergent composition, comprising a) an aklanolamine; b) a sulfite; c) a perfume oil comprising aldehyde or ketone; and d) a sulfur-containing pro-perfume compound.

In yet another aspect, the present invention is directed to a detergent product comprising the liquid detergent composition and a container having multiple compartments, wherein the composition is contained in one compartment of the multiple compartments, and wherein an amine-assisted delivery system (which would result in discoloration when incorporated in the aforementioned composition) is present in another compartment of the multiple compartments.

### BRIEF DESCRIPTION OF THE DRAWINGS

FIG. 1 is a graph showing the headspace data of Examples 3 and 4.

### DETAILED DESCRIPTION OF THE INVENTION

### Definitions

As used herein, the term “detergent product” means a product relating to cleaning or treating: fabrics, hard or soft surfaces, skin, hair, or any other surfaces in the area of fabric care, home care, skin care, and hair care. The detergent products include, but are not limited to: laundry detergent, laundry detergent additive, laundry bar, fabric softener, carpet cleaner, floor cleaner, bathroom cleaner, toilet cleaner, sink cleaner, dishwashing detergent, air care, car care, skin moisturizer, skin cleanser, skin treatment emulsion, shaving cream, skin mask, hair shampoo, hair conditioner, and the like. The term “situs” herein refers to surfaces (e.g., fabrics, hard or soft surfaces, skin, hair) treated with the detergent product.

As used herein, the term “liquid detergent composition” refers to detergent compositions that are in a form selected from the group consisting of liquid, gel, cream, and combinations thereof. The liquid detergent composition may be either aqueous or non-aqueous, and may be anisotropic, isotropic, or combinations thereof.

As used herein, the term “pouch” refers to a type of detergent product comprising a water-soluble film and a detergent composition contained in the water-soluble film. The term “compartment” herein refers to a portion of the pouch in which a detergent composition is enveloped by the water-soluble film.

As used herein, the term “container” refers to a packaging container which a product is contained in and is used for storage, transport, and dispensing. The container could be a bottle, a jar, a cup, and the like.

As used herein, the term “perfume oil”, as used herein, refers to free, volatile oils comprising one or more perfume raw materials (PRMs) and optional solvents, in which no chemical compounds are intentionally added to combine or react with the PRMs, and therefore the PRMs are free to become volatized and available for olfactory detection by a user. The term “aldehyde or ketone” herein means an aldehyde or ketone chemical moiety, and the term “perfume oil comprising aldehyde or ketone” herein refers to the perfume oils which comprise aldehyde or ketone-containing PRMs. The term “perfume delivery system” herein refers to the combination or reaction product of PRMs with certain chemical compounds, which enhances the deposition efficiency of the perfume onto a situs and/or a controlled release of the perfume. For example, the sulfur-containing pro-perfume is a type of perfume delivery system. The term “perfume” herein is a general term that could refer to PRM, perfume delivery system, perfume oil, or a pleasant scent achieved thereby. The terms “scent” and “odor” are synonymous.

As used herein, when a composition is “substantially free” of a specific ingredient, it is meant that the composition comprises less than a trace amount, alternatively less than 0.1%, alternatively less than 0.01%, alternatively less than 0.001%, by weight of the composition, of the specific ingredient.

As used herein, the articles including “a” and “an” when used in a claim, are understood to mean one or more of what is claimed or described.

As used herein, the terms “comprise”, “comprises”, “comprising”, “include”, “includes”, “including”, “contain”, “contains”, and “containing” are meant to be non-limiting, i.e., other steps and other ingredients which do not affect the end of result can be added. The above terms encompass the terms “consisting of” and “consisting essentially of”.

### Liquid Detergent Composition

The liquid detergent composition of the present invention comprises a) an aklanol amine; b) a sulfite; c) a perfume oil comprising aldehyde or ketone; and d) a sulfur-containing pro-perfume compound. The liquid detergent composition is preferably a liquid laundry detergent composition, or a liquid fabric softener composition, or a liquid dishwashing detergent composition, more preferably is a liquid laundry detergent composition.

Preferably, in the liquid detergent composition, the alkanolamine is present from about 0.1% to about 10%, by weight of the composition; the sulfite is present from about 0.01% to about 3%, by weight of the composition; the perfume oil comprising aldehyde or ketone is present from about 0.0001% to about 5%, by weight of the composition; and the sulfur-containing pro-perfume compound is present from about 0.0001% to about 5%, by weight of the composition. More preferably, in the liquid detergent composition, the alkanolamine is present from about 0.3% to about 8%, by weight of the composition; the sulfite is present from about 0.05% to about 1%, by weight of the composition; the perfume oil comprising aldehyde or ketone is present from about 0.1% to about 3%, by weight of the composition; and the sulfur-containing pro-perfume compound is present from about 0.01% to about 3%, by weight of the composition.

The liquid detergent composition herein may be acidic or alkali or pH neutral, depending on the ingredients incorporated in the composition. The pH range of the liquid detergent composition is preferably from about 5 to about 11, more preferably from about 6 to about 10, even more preferably from about 7 to about 9. In a pouch execution, an alkali composition (e.g., with a pH of from about 7 to about 9) is preferred due to being more compatible with the water-soluble film of the pouch, e.g., a polyvinyl alcohol film.

Alkanolamine

The alkanolamine incorporated in the liquid detergent composition herein functions as a neutralizer to achieve the desired pH of the composition. Particularly, the alkanolamine is utilized to neutralize anionic surfactants, such as Linear Alkylbenzene Sulfonate (LAS), or certain acidic ingredients, such as fatty acid, thus achieving a preferred alkali composition.

The alkanolamine herein could be any alkanolamine known in the art. Preferably, the alkanolamine is selected from the group consisting of methanolamine, ethanolamine, propaneolamine, and a combination thereof, more preferably is ethanolamine, such as mono-, di-, and tri-ethanolamines, and even more preferably is monoethanolamine.

The alkanolamine could be present at any suitable level in the liquid detergent composition. Preferably, the alkanolamine is present from about 0.1% to about 10%, alternatively from about 0.3% to about 8%, alternatively from about 0.5% to about 7%, alternatively from about 0.7 to about 5%, alternatively from about 0.8% to about 2%, by weight of the composition.

Sulfite

The sulfite herein could be any sulfite known in the art. Preferably, the sulfite is selected from the group consisting of sodium hydrogen sulfite, sodium sulfite, potassium hydrogen sulfite, potassium sulfite, and a combination thereof. More preferably, the sulfite is sodium hydrogen sulfite or potassium sulfite.

Although there is some reasonable range of the level of the sulfite that can be incorporated in the composition of the present invention, there is a balance that needs to be struck. On the one hand, the sulfite level needs to be sufficient to prevent the Schiff-base reaction between the alkanolamine and the perfume oil comprising aldehyde or ketone. On the other hand, a relatively high level of the sulfite leads to unnecessary consumption of the aldehyde or ketone contained in the perfume oil, and the character and intensity of the perfume becomes difficult to preserve. In the present invention, it has been surprisingly found that a stable liquid detergent composition (i.e., without discoloration) having improved perfume longevity is obtained whilst minimizing the sulfite level. In one embodiment, the sulfite is present from about 0.01% to about 3%, alternatively from about 0.05% to about 1%, alternatively from about 0.08% to about 0.5%, alternatively from about 0.1% to about 0.4%, by weight of the composition.

Perfume Oil Comprising Aldehyde or Ketone

The perfume oil comprising aldehyde or ketone is incorporated in the liquid detergent composition herein to provide an immediate scent to users, without requiring any triggers to release the perfume. For example, each time when a user opens the container that contains a composition comprising such a perfume oil or applies the composition to a situs, the user would be able to smell a scent from the perfume oil. A wide variety of perfume oils comprising aldehyde or ketone are suitable for use herein. The perfume oil comprising ketone is more preferred.

The perfume oil comprising ketone can comprise any PRMs which contain one or more ketone moieties and which can impart a desirable scent. Preferably, the perfume oil comprising ketone comprises a PRM selected from the group consisting of buccoxime; iso jasmone; methyl beta naphthyl ketone; musk indanone; tonalid/musk plus; alpha-damascone, beta-damascone, delta-damascone, iso-damascone, damascenone, damarose, methyl-dihydrojasmonate, menthone, carvone, camphor, fenchone, alpha-ionone, beta-ionone, dihydro-beta-ionone, gamma-methyl so-called ionone, fleuramone, dihydrojasmone, cis-jasmone, iso-e-super, methyl-cedrenyl-ketone or methyl-cedrylone, acetophenone, methyl-acetophenone, para-methoxy-acetophenone, methyl-beta-naphtyl-ketone, benzyl-acetone, benzophenone, para-hydroxy-phenyl-butanone, celery ketone or livescone, 6-isopropyldecahydro-2-naphtone, dimethyl-octenone, freskomenthe, 4-(1-ethoxyvinyl)-3,3,5,5,-tetramethyl-cyclohexanone, methyl-heptenone, 2-(2-(4-methyl-3-cyclohexen-1-yl)propyl)-cyclopentanone, 1-(p-menthen-6(2)-yl)-1-propanone, 4-(4-hydroxy-3-methoxyphenyl)-2-butanone, 2-acetyl-3,3-dimethyl-norbornane, 6,7-dihydro-1,1,2,3,3-pentamethyl-4(5h)-indanone, 4-damascol, dulcinyl or cassione, gelsone, hexalon, isocyclemone e, methyl cyclocitrone, methyl-lavender-ketone, orivon, para-tertiary-butyl-cyclohexanone, verdone, delphone, muscone, neobutenone, plicatone, veloutone, 2,4,4,7-tetramethyl-oct-6-en-3-one, tetrameran, hedione, floralozone, gamma undecalactone, ethylene brassylate, pentadecanolide, methyl nonyl ketone, cyclopentadecanone, cyclic ethylene dodecanedioate, 3,4,5,6-tetrahydropseudoionone, 8-hexadecenolide, dihydrojasmone, 5-cyclohexadecenone, and a combination thereof.

In one embodiment, the perfume oil comprising ketone comprises a PRM selected from the group consisting of alpha-damascone, delta-damascone, iso-damascone, carvone, gamma-methyl-ionone, beta-ionone, iso-e-super, 2,4,4,7-tetramethyl-oct-6-en-3-one, benzyl acetone, beta-damascone, damascenone, methyl dihydrojasmonate, methyl cedrylone, hedione, floralozone, and a combination thereof. Preferably, the perfume oil comprising ketone comprises delta-damascone.

The perfume oil comprising aldehyde can comprise any PRMs which contain one or more aldehyde moieties and which can, like the perfume oil comprising ketone, also impart a desirable scent. Preferably, the perfume oil comprising aldehyde comprises a PRM selected from the group consisting of adoxal; anisic aldehyde; cymal; ethyl vanillin; florhydral; helional; heliotropin; hydroxycitronellal; koavone; lauric aldehyde; lyral; triplal, melonal, methyl nonyl acetaldehyde; p. t. bucinal; phenyl acetaldehyde; undecylenic aldehyde; vanillin; 2,6,10-trimethyl-9-undecenal, 3-dodecen-1-al, alpha-n-amyl cinnamic aldehyde, 4-methoxybenzaldehyde, benzaldehyde, 3-(4-tert butylphenyl)-propanal, 2-methyl-3-(para-methoxyphenyl propanal, 2-methyl-4-(2,6,6-trimethyl-2(1)-cyclohexen-1-yl) butanal, 3-phenyl-2-propenal, cis-/trans-3,7-dimethyl-2,6-octadien-1-al, 3,7-dimethyl-6-octen-1-al, [(3,7-dimethyl-6-octenyl)oxyl]acetaldehyde, 4-isopropylbenzyaldehyde, 1,2,3,4,5,6,7,8-octahydro-8,8-dimethyl-2-naphthaldehyde, 2,4-dimethyl-3-cyclohexen-1-carboxaldehyde, 2-methyl-3-(isopropylphenyl)propanal, 1-decanal; decyl aldehyde, 2,6-dimethyl-5-heptenal, 4-(tricyclo[5.2.1.0(2,6)]-decylidene-8)-butanal, octahydro-4,7-methano-1h-indenecarboxaldehyde, 3-ethoxy-4-hydroxy benzaldehyde, para-ethyl-alpha, alpha-dimethyl hydrocinnamaldehyde, alpha-methyl-3,4-(methylenedioxy)-hydrocinnamaldehyde, 3,4-methylenedioxybenzaldehyde, alpha-n-hexyl cinnamic aldehyde, m-cymene-7-carboxaldehyde, alpha-methyl phenyl acetaldehyde, 7-hydroxy-3,7-dimethyl octanal, undecenal, 2,4,6-trimethyl-3-cyclohexene-1-carboxaldehyde, 4-(3)(4-methyl-3-pentenyl)-3-cyclohexen-carboxaldehyde, 1-dodecanal, 2,4-dimethyl cyclohexene-3-carboxaldehyde, 4-(4-hydroxy-4-methyl pentyl)-3-cylohexene-1-carboxaldehyde, 7-methoxy-3,7-dimethyloctan-1-al, 2-methyl undecanal, 2-methyl decanal, 1-nonanal, 1-octanal, 2,6,10-trimethyl-5,9-undecadienal, 2-methyl-3-(4-tertbutyl)propanal, dihydrocinnamic aldehyde, 1-methyl-4-(4-methyl-3-pentenyl)-3-cyclohexene-1-carboxaldehyde, 5 or 6 methoxy0hexahydro-4,7-methanoindan-1 or 2-carboxaldehyde, 3,7-dimethyloctan-1-al, 1-undecanal, 10-undecen-1-al, 4-hydroxy-3-methoxy benzaldehyde, 1-methyl-3-(4-methylpentyl)-3-cyclhexenecarboxaldehyde, 7-hydroxy-3,7-dimethyl-octanal, trans-4-decenal, 2,6-nonadienal, para-tolylacetaldehyde; 4-methylphenylacetaldehyde, 2-methyl-4-(2,6,6-trimethyl-1-cyclohexen-1-yl)-2-butenal, ortho-methoxycinnamic aldehyde, 3,5,6-trimethyl-3-cyclohexene carboxaldehyde, 3,7-dimethyl-2-methylene-6-octenal, phenoxyacetaldehyde, 5,9-dimethyl-4,8-decadienal, peony aldehyde (6,10-dimethyl-3-oxa-5,9-undecadien-1-al), hexahydro-4,7-methanoindan-1-carboxaldehyde, 2-methyl octanal, alpha-methyl-4-(1-methyl ethyl)benzene acetaldehyde, 6,6-dimethyl-2-norpinene-2-propionaldehyde, para methyl phenoxy acetaldehyde, 2-methyl-3-phenyl-2-propen-1-al, 3,5,5-trimethyl hexanal, hexahydro-8,8-dimethyl-2-naphthaldehyde, 3-propyl-bicyclo[2.2.1]-hept-5-ene-2-carbaldehyde, 9-decenal, 2-decenal, 3-methyl-5-phenyl-1-pentanal, methylnonyl acetaldehyde, 1-p-menthene-q-carboxaldehyde, citral, lilial, cumin aldehyde, mandarin aldehyde, datilat, geranial, cyclamen aldehyde, capraldehyde, undecanal, lauraldehyde, nonaldehyde, 1,2-dodecenal, cis-8-undecen-1-al, tetrahydrogeranial, and a combination thereof.

In one embodiment, the perfume oil comprising aldehyde comprises a PRM selected from the group consisting of citral, 1-decanal, benzaldehyde, florhydral, 2,4-dimethyl-3-cyclohexen-1-carboxaldehyde; cis/trans-3,7-dimethyl-2,6-octadien-1-al; heliotropin; 2,4,6-trimethyl-3-cyclohexene-1-carboxaldehyde; 2,6-nonadienal; alpha-n-amyl cinnamic aldehyde, alpha-n-hexyl cinnamic aldehyde, p-t-bucinal, lyral, cymal, methyl nonyl acetaldehyde, trans-2-nonenal, lilial, trans-2-nonenal, datilat, anisic aldehyde, geranial, i-octanal, helional, cuminaldehyde, triplal, melonal, and a combination thereof.

The perfume oil comprising aldehyde or ketone could be present at any suitable level in the liquid detergent composition. Preferably, the perfume oil comprising aldehyde or ketone is present from about 0.0001% to about 5%, alternatively from about 0.01% to about 4%, alternatively from about 0.1% to 3%, alternatively from about 0.5% to about 2%, by weight of the composition.

Sulfur-Containing Pro-Perfume Compound

The term “sulfur-containing pro-perfume compound” herein refers to a type of pro-perfume compound that contains sulfur. The term “pro-perfume compound” herein refers to compounds resulting from the reaction of PRMs with other chemicals, which have a covalent bond between one or more PRMs and these other chemicals. The PRM is converted into a new material called a pro-perfume compound, which then may release the original PRM (i.e., pre-converted) upon exposure to a trigger such as water or light or atmospheric oxygen. Suitable pro-perfume compounds and methods of making the same can be found in U.S. Pat. Nos. 7,018,978; 6,861,402; 6,544,945; 6,093,691; 6,165,953; and 6,096,918.

The sulfur-containing pro-perfume compound herein may comprise a compound of formula (I):

Y—S-G-Q (I)

wherein:

(i) Y is a radical selected from the group consisting of (Y-1) to (Y-7) shown herein below, including isomeric forms:

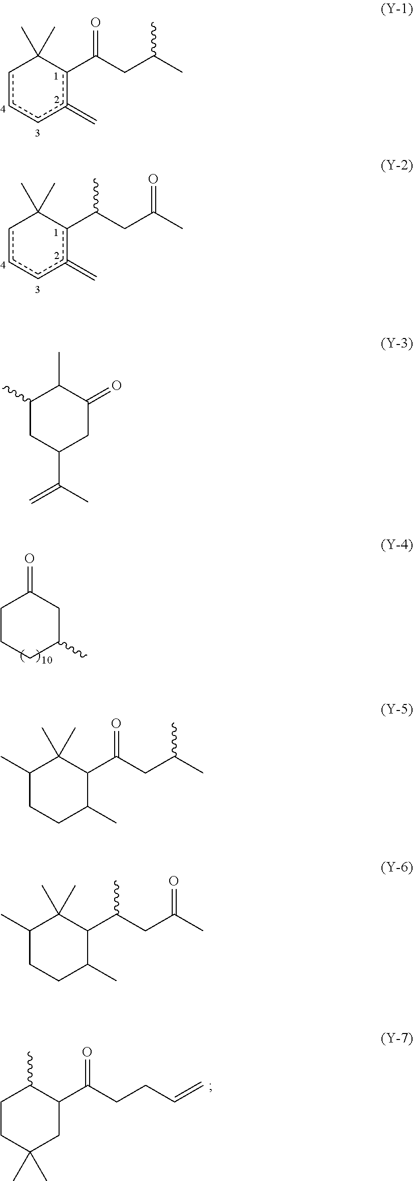

wherein the wavy lines represent the location of the sulfur bond, and the dotted lines represent a single or double bond;

(ii) G is selected from a divalent or trivalent radical derived from a linear or branched alkyl or alkenyl radical having from 2 to 15 carbon atoms; and

(iii) Q is selected from a hydrogen, a —S—Y group, or a —NR²—Y group, wherein Y is independently selected as defined above, and R² is selected from a hydrogen or a C₁-C₃ alkyl group.

In one embodiment, G is a divalent or trivalent radical, preferably a divalent radical derived from a linear or branched alkyl or alkenyl radical having from 2 to 15 carbon atoms, substituted with one or more groups selected from the group consisting of —OR¹, —NR¹₂, —COOR¹, R¹ groups, and a combination thereof, wherein R¹ is selected from a hydrogen or a C₁ to C₆ alkyl or alkenyl group. Preferably, G is a divalent radical derived from a linear or branched alkyl or alkenyl radical having from 2 to 15 carbon atoms, substituted with at least one —COOR¹ group, preferably substituted with a —COOR¹ group, wherein R¹ is selected from a hydrogen or a C₁ to C₆ alkyl or alkenyl group. Even more preferably, G is a divalent radical derived from a linear alkyl radical having a —CH₂CH(COOR¹) group, wherein R¹ is a hydrogen or a methyl or ethyl group. In an alternative embodiment, G is a divalent radical derived from a linear alkyl radical having from 8 to 15 carbon atoms which is either substituted or un-substituted.

In one embodiment, the sulfur-containing pro-perfume compound is a compound of formula (I) wherein Y is selected from Y-1, Y-2 or Y-3 groups as defined above, and G and Q are defined in any one of the above-described embodiments.

Preferably, the sulfur-containing pro-perfume compound is selected from the group consisting of methyl or ethyl 2-(4-oxo-4-(2,6,6-trimethylcyclohex-3-en-1-yl)butan-2-ylamino)-3-(4-oxo-4-(2,6,6-trimethylcyclohex-3-en-1-yl)butan-2-ylthio)propanate, methyl or ethyl 2-(4-oxo-4-(2,6,6-trimethylcyclohex-2-en-1-yl)butan-2-ylamino)-3-(4-oxo-4-(2,6,6-trimethylcyclohex-2-en-1-yl)butan-2-ylthio)propanate, methyl or ethyl 2-(2-oxo-4-(2,6,6-trimethylcyclohex-1-en-1-yl)butan-4-ylamino)-3-(2-oxo-4-(2,6,6-trimethylcyclohex-1-en-1-yl)butan-4-ylthio)propanate, methyl or ethyl 2-(2-oxo-4-(2,6,6-trimethylcyclohex-2-en-1-yl)butan-4-ylamino)-3-(2-oxo-4-(2,6,6-trimethylcyclohex-2-en-1-yl)butan-4-ylthio)propanate, 3-(dodecylthio)-1-(2,6,6-trimethylcyclohex-3-en-1-yl)-1-butanone, 3-(dodecylthio)-1-(2,6,6-trimethylcyclohex-2-en-1-yl)-1-butanone, 4-(dodecylthio)-4-(2,6,6-trimethylcyclohex-2-en-1-yl)-2-butanone, 4-(dodecylthio)-4-(2,6,6-trimethylcyclohex-1-en-1-yl)-2-butanone, 2-dodecylsulfanyl-5-methyl-heptan-4-one, 2-cyclohexyl-1-dodecylsulfanyl-hept-6-en-3-one, 3-(dodecylthio)-5-isopropenyl-2-methylcyclohexanone, and a combination thereof.

More preferably, the sulfur-containing pro-perfume compound is selected from the group consisting of 3-(dodecylthio)-1-(2,6,6-trimethylcyclohex-3-en-1-yl)-1-butanone, 4-(dodecylthio)-4-(2,6,6-trimethylcyclohex-2-enl-yl)-2-butanone, 4-(dodecylthio)-4-(2,6,6-trimethylcyclohex-1-en-1-yl)-2-butanone and 3-(dodecylthio)-5-isopropenyl-2-methylcyclohexanone, and a combination thereof. 3-(dodecylthio)-1-(2,6,6-trimethylcyclohex-3-en-1-yl)-1-butanone is the most preferred sulfur-containing pro-perfume compound, such as Haloscent® D available from Firmenich located in Geneva, Switzerland.

The sulfur-containing pro-perfume compound can be present at any suitable level in the liquid detergent composition. Preferably, the sulfur-containing pro-perfume compound is present at least about 0.0001%, alternatively from about 0.0001% to about 5%, alternatively from about 0.001% to about 4%, alternatively from about 0.01% to about 3%, alternatively from about 0.1% to about 2%, alternatively from about 0.3% to about 1%, by weight of the composition.

### Other Perfume Delivery Systems

In addition to the required sulfur-containing pro-perfume compound, the liquid detergent composition herein may comprise other types of perfume delivery systems. Non-limiting examples of the perfume delivery systems suitable for use herein include the following: non-sulfur-containing pro-perfume compound, perfume microcapsule (PMC), cyclodextrin, zeolite & inorganic carrier, starch encapsulated accord, amine-assisted perfume delivery system (AAD), and polyacrylate capsule. Descriptions on these perfume delivery systems can be found in US Patent Publication No. 2007/0275866 from paragraphs [0025] to [0030].

Such a combination of multiple types of perfume delivery systems allows the controlled release of a variety of different scent imparting substances, which is an advantage over slowly releasing just one perfume as will happen if just one perfume oil or perfume delivery system is used. For example, the composition of the present invention further comprises a PMC. The PMC comprises a wall material and a core material of PRM that is encapsulated within the wall material. The PRM is not being released from the PMC until the wall material ruptures because of a mechanical stress (e.g., friction), i.e., the perfume release from the PMC is at different time points from the required perfume oil and sulfur-containing pro-perfume compound.

On the other hand, certain perfume delivery systems that are not compatible in such a context of liquid detergent composition are preferably not contained in the composition. For example, as mentioned previously, an AAD that comprises a polymeric amine and PRM release aldehydes or ketones to react with the sulfite, thereby undermining the function of preventing the Schiff-base reaction by the sulfite and causing discoloration. Thus, in one embodiment, the liquid detergent composition is substantially free of an AAD, alternatively less than 0.1%, alternatively less than 0.01%, alternatively less than 0.001%, by weight of the composition, of an AAD. In alternative embodiment, the composition further comprises an AAD and a dye that masks the discoloration caused by the AAD.

The levels of these perfume delivery systems (not including the sulfur-containing pro-perfume compound) in the liquid detergent composition will depend on factors like the specific type of the composition. Preferably, when present, the total levels of these perfume delivery systems (not including the sulfur-containing pro-perfume compound) in the liquid detergent composition are at least about 0.0001%, alternatively from about 0.0001% to about 10%, alternatively from about 0.001% to about 5%, alternatively from about 0.1% to about 2%, by weight of the composition.

### Additional Ingredient

The liquid detergent composition of the present invention may comprise one or more additional ingredients. Suitable additional materials include but are not limited to: anionic surfactants, cationic surfactants, nonionic surfactants, fatty acids, builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, photobleaches, structure elasticizing agents, fabric softeners, carriers, hydrotropes, processing aids, solvents, hueing agents, anti-microbial agents, structurants and/or pigments. In addition to the disclosure below, suitable examples of such other adjuncts and levels of use are found in U.S. Pat. Nos. 5,576,282, 6,306,812, and 6,326,348. The precise nature of these additional ingredients and the levels thereof in the liquid detergent composition will depend on factors like the specific type of the composition and the nature of the cleaning operation for which it is to be used.

In one embodiment, the composition comprises an anionic surfactant. Non-limiting examples of anionic surfactants include: linear alkylbenzene sulfonate (LAS), preferably C₁₀-C₁₆ LAS; C₁₀-C₂₀ primary, branched-chain and random alkyl sulfates (AS); C₁₀-C₁₈ secondary (2,3)alkyl sulfates; sulphated fatty alcohol ethoxylate (AES), preferably C₁₀-C₁₈ alkyl alkoxy sulfates (AEₓS) wherein preferably x is from 1-30, more preferably x is 1-3; C₁₀-C₁₈ alkyl alkoxy carboxylates preferably comprising 1-5 ethoxy units; mid-chain branched alkyl sulfates as discussed in U.S. Pat. No. 6,020,303 and U.S. Pat. No. 6,060,443; mid-chain branched alkyl alkoxy sulfates as discussed in U.S. Pat. No. 6,008,181 and U.S. Pat. No. 6,020,303; modified alkylbenzene sulfonate (MLAS) as discussed in WO 99/05243, WO 99/05242, and WO 99/05244; methyl ester sulfonate (MES); and alpha-olefin sulfonate (AOS). Preferably, the composition comprises an anionic surfactant selected from the group consisting of LAS, AES, and a combination thereof. More preferably, the composition comprises a LAS. As mentioned previously, the alkanolamine is utilized to neutralize anionic surfactants, such as the LAS. The total level of the anionic surfactant(s) may be from about 5% to about 95%, alternatively from about 8% to about 70%, alternatively from about 10% to about 50%, alternatively from about 12% to about 40%, alternatively from about 15% to about 30%, by weight of the liquid detergent composition. The LAS may be present from about 2% to about 25%, alternatively from about 3% to about 21%, alternatively from about 15% to about 20%, by weight of the liquid detergent composition.

In one embodiment, the composition comprises a fatty acid. The fatty acid herein is preferably selected from those having a chain length of 6 or more carbon atoms, more preferably is C₁₂-C₁₈ fatty acid. As mentioned previously, the alkanolamine is utilized to neutralize acidic ingredients, such as the fatty acid. The fatty acid may be present from about 0.5% to about 8%, alternatively from about 1% to about 7%, alternatively from about 4% to about 6%, by weight of the liquid detergent composition.

In one embodiment, the liquid detergent composition further comprises a dye that imparts a color to the composition. Particularly when there is discoloration of the composition caused by reactions between certain ingredients, such incorporation of a dye is preferred so as to mask the discoloration.

### Composition Preparation

The liquid detergent composition of the present invention is generally prepared by conventional methods such as those known in the art of making liquid detergent compositions. Such methods typically involve mixing the essential and optional ingredients in any desired order to a relatively uniform state, with or without heating, cooling, application of vacuum, and the like, thereby providing liquid detergent compositions containing ingredients in the requisite concentrations.

### Pouch

One aspect of the present invention is directed to a pouch comprising the liquid detergent composition and a water-soluble film, wherein the composition is contained within the water-soluble film. The pouch herein is typically a closed structure, made of the water-soluble film enclosing an internal volume which comprises the liquid detergent composition. The pouch can be of any form and shape which are suitable to hold and protect the composition, e.g. without allowing the release of the composition from the pouch prior to contact of the pouch to water. The exact execution will depend on factors like the type and amount of the composition in the pouch, the number of compartments in the pouch, the characteristics required for the water-soluble film to hold, protect, and release the composition.

The water-soluble film of the pouch is preferably made of a polymer. The film can be obtained from methods known in the art, e.g., by casting, blow molding, extrusion molding, injection molding of the polymer. Non-limiting examples of the polymer for making the water-soluble film include: polyvinyl alcohols (PVAs), polyvinyl pyrrolidone, polyalkylene oxides, (modified) cellulose, (modified) cellulose-ethers or -esters or -amides, polycarboxylic acids and salts including polyacrylates, copolymers of maleic/acrylic acids, polyaminoacids or peptides, polyamides including polyacrylamide, polysaccharides including starch and gelatine, natural gums such as xanthum and carragum. Preferably, the water-soluble film comprises a polymer selected from the group consisting of polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, polyvinyl alcohols, hydroxypropyl methyl cellulose (HPMC), and a combination thereof. Most preferably, the water-soluble film is polyvinyl alcohol, e.g., M8639 available from MonoSol. Suitable polymers for making the water-soluble film of the pouch can be found in U.S. Pat. No. 6,995,126.

The pouch herein may comprise a single compartment or multiple compartments, preferably comprise multiple compartments, e.g., two compartments or three compartments. In the multi-compartment execution, the pouch comprises multiple films which form the multiple compartments, i.e., the inner volume of the multiple films is divided into the multiple compartments. Examples of these multi-compartment pouches are described in U.S. Pat. Nos. 4,973,416, 5,224,601, and 8,066,818.

In a multi-compartment execution, it is preferably that at least two of the multiple compartments have different solubility under the same condition, releasing the compositions which they partially or totally envelop at different times, e.g., at different time points during a wash cycle. The term “solubility” herein is not intended to refer to total solubility of a film but to the point at which the pouch in the wash solution breaks to release its content. Difference in solubility of each compartment can be achieved by means of films made of different polymers, films of different thickness, or films which solubility is temperature dependent, or by properties of the compartment (e.g., size, weight, relative position of the compartment). One example of the means of obtaining delayed release by pouches with different compartments, where the compartments are made of films having different solubility are taught in WO 02/08380. In one preferred embodiment, the required liquid detergent composition is contained in a compartment that dissolves later than other compartments of the pouch during a wash cycle. This enables longer time of the sulfur-containing pro-perfume compound being hold in the compartment, and therefore less amounts of the compound being adversely affected by certain ingredients contained in and release from another compartment, e.g., a bleach, during the wash cycle.

In the multi-compartment execution, the required liquid detergent composition is contained in one or more compartments of the multiple compartments, preferably in one compartment of the multiple compartments. The multiple compartments of the pouch may comprise either the same composition or different compositions. The term “different compositions” herein refer to compositions that differ in at least one ingredient. In one embodiment, each of the multiple compartments comprises the same composition, which is the liquid detergent composition required by the present invention. Alternatively, at least two of the multiple compartments of the pouch comprise two different compositions. In a preferred embodiment, each of the multiple compartments has different colors, e.g., comprising different dyes that impart different colors to the multiple compositions contained in the multiple compartments, thus being more appealing to users.

In one preferred embodiment, the pouch comprises two compartments, wherein the two compartments comprise a first compartment and a second compartment, wherein the required liquid detergent composition is contained in the first compartment and a second composition (either in a liquid or solid form) is contained in the second compartment. In particular, when an AAD is present, it is preferably that the second composition comprises the AAD (i.e., the AAD is contained in the second compartment).

In another preferred embodiment, the pouch comprises three compartments, wherein the three compartments comprise a first compartment, a second compartment, and a third compartment. Preferably, the first compartment and the second compartment are placed side-by-side and superposed (i.e., placed above) onto the third compartment, wherein the required liquid detergent composition is contained in one of the first compartment, the second compartment, and the third compartment. More preferably, the required liquid detergent composition is contained in the first compartment or the second compartment as these two side-by-side compartments dissolve later than the first compartment during a wash cycle. When the required liquid detergent composition is contained in the first compartment, the second compartment and the third compartment may comprise either a liquid or solid composition. For example, the first compartment comprises the required liquid detergent composition, the second compartment comprises a second composition in a liquid form, and the third compartment comprises a third composition in a liquid form, wherein the second composition and the third composition are either the same or different. An alternative example is that, the first compartment comprises the required liquid detergent composition, the second compartment comprises a second composition in a liquid form, and the third compartment comprises a third composition in a solid form.

The pouch may be of such a size that it conveniently contains either a unit dose amount of the composition herein, suitable for the required operation, for example one wash, or only a partial dose, to allow a user greater flexibility to vary the amount used, e.g., depending on the size or degree of soiling of the wash load. In one embodiment, the pouch has an internal volume of from about 10 ml to about 50 ml, preferably from about 12 ml to about 30 ml, more preferably from about 15 to about 25 ml. In particular, more suitable pouches have a square or rectangular base and a height of from about 1 cm to about 5 cm, preferably from about 1 cm to about 4 cm. In terms of weight, the pouch preferably has a weight of from about 5 grams to about 50 grams, more preferably from about 10 grams to about 40 grams, even more preferably from about 15 grams to about 30 grams.

The pouch of the present invention can be made by any suitable processes known in the art. Example processes of making the pouch can be found in U.S. Pat. Nos. 6,995,126, 7,127,874, 8,156,713, 7,386,971, 7,439,215, and US Patent Publication No. 2009/199877. For example, the multi-compartment pouch herein is obtainable by the process of closing an open compartment with a pre-sealed compartment, wherein the process forms a second seal on the pre-sealed compartment which is in a different position to the first seal of the pre-sealed compartment, as disclosed in U.S. Pat. No. 6,995,126. Alternatively, the multi-compartment pouch could be obtainable by the steps of: a) making a first compartment in a first pouch making unit having a first forming surface, wherein the first compartment is made by placing a water-soluble film on the surface of the first pouch making unit, the surface has moulds into which the water-soluble film is drawn to form an open compartment, the open compartment is then filled with a detergent composition, and preferably the resulting compartment is subsequently closed; b) making a second compartment in a second pouch making unit having a second forming surface, wherein the second compartment is made in a similar manner to the first compartment and preferably is subsequently closed; c) combining the first and second compartment wherein the first and second forming surfaces bring the first and second compartments into contact and exert pressure on them to seal the first and second compartments to form a pouch; and d) cutting the resulting pouches to produce individual pouches having multiple compartments, as disclosed in US Patent Publication No. 2009/199877.

### Detergent Product

Another aspect of the present invention is directed to a detergent product comprising the liquid detergent composition and a container having multiple compartments (i.e., the inner volume of the container is divided into the multiple compartments), wherein the multiple compartments comprise a first compartment and second compartment, wherein the composition is contained in the first compartment and a second composition is contained in the second compartment, and wherein the second composition comprises an AAD. The container herein is preferably a bottle (e.g., plastic or glass or metal) having multiple compartments. Alternatively, the container is a water insoluble sachet.

### Test Method

Method for Determining of Odor Performance for Detergent Compositions

The odor performance of detergent compositions is characterized by Olfactory Grading Data and Headspace Data. The term “headspace” herein refers to an accessible headspace and is meant to include the vapor located above a detergent composition or a fabric treated by the composition in a container that is suitable for olfactory sampling by a user upon opening the closure of the container.

A. Sample Preparation

An 86/14 cotton/poly terry washcloth (obtained from EMC, 7616 Reinfold Drive, Cincinnati, Ohio 45237) is used as the test substrate. The substrate and test solution (or test pouch) are placed in Kenmore 600 3.5 cu. ft. Top Load Washing Machine and washed for 12 minutes at 30 with 64 liters of water. The washed substrate is then rinsed once with 64 liters of water for 12 minutes. The water used for washing and rinsing has 6 gpg (grains per gallon) hardness. The fabric samples are obtained.

B. Olfactory Grading

Wet and line dried fabric samples obtained in above A. Sample Preparation is evaluated by perfumers at a scale for olfactory grading. When the olfactory grading data of two samples are compared, a difference of −3/+3 represents a difference that is user noticeable. 6 replicates are analyzed for each Example.

C. Headspace Analysis

Wet and line dried fabric samples obtained in above A. Sample Preparation is cut into 4×4 cm squares as aliquots and analyzed by fast headspace GC/MS (Gas Chromatograph with Mass Selective Detector) approach. The aliquots are transferred to 25 ml headspace vials and then are equilibrated for 10 minutes at 75. The headspace above the aliquots is sampled via SPME (Solid Phase Micro Extraction) approach using SPME fiber of 50/30 μm DVB/Carboxen/PDMS (Superlco 57328-U) for 5 minutes. The SPME fiber was subsequently on-line thermally desorbed into the gas chromatograph (Thermo Finnigan). The analytes are analyzed by fast GC/MS in full scan mode. Ion extraction of 192 masses for damascone is used to calculate the damascone headspace responses (expressed in area counts). 6 replicates are analyzed for each Example.

Method for Determining of Color Stability for Detergent Compositions

The color stability of detergent compositions is tested by aging juice during 10 days at 50. The color of the fresh and aged sample is measured with a “HunterLab Colorimetric Spectrophotometer”, and L, a- and b-values are obtained. The L-value can vary from 0 to 100, 0 being black and 100 being white. The a-value goes from green to red, and the b-value goes from blue to yellow. Δ-values have been calculated to evaluate color stability.

### EXAMPLE

The Examples herein are meant to exemplify the present invention but are not used to limit or otherwise define the scope of the present invention. Examples 1A-1D, 2A-2B, and 3A-3B are examples according to the present invention, and Examples 4A-4E are comparative examples.

### Examples 1A-1D

### Formulations of liquid laundry detergent compositions

The following liquid laundry detergent compositions shown in Table 1 are made comprising the listed ingredients in the listed proportions (weight %).

TABLE 1

| | 1A | 1B | 1C | 1D |
|---|---|---|---|---|
| C₁₁-C₁₃LAS | 3 | 3 | 3 | 3 |
| C₁₂-C₁₄AE₁₋₃S | 7 | 7 | 7 | 7 |
| Neodol ®25-7 a | 4 | 4 | 4 | 4 |
| Citric acid | 3 | 3 | 3 | 3 |
| C₁₂-C₁₈ fatty acid | 4 | 4 | 4 | 4 |
| DTPMP b | 0.2 | 0.2 | 0.2 | 0.2 |
| 1,2 propanediol | 5 | 5 | 5 | 5 |
| Ethanol | 1 | 1 | 1 | 1 |
| Monoethanolamine | 1 | 1 | 1 | 1 |
| NaOH | up to pH 8 | | | |
| Protease | 0.5 | 0.5 | 0.5 | 0.5 |
| Amylase | 0.1 | 0.1 | 0.1 | 0.1 |
| Potassium sulfite | 0.2 | 0.2 | 0.2 | 0.2 |
| Sulfur-containing pro-perfume | 0.5 | 0.5 | 0.5 | 0.5 |
| compound c | | | | |
| Lupasol ® d | 0 | 0 | 0 | 0.1 |
| Perfume microcapsule | 0 | 0 | 0.8 | 0 |
| Dye | 0 | 0.002 | 0 | 0.002 |
| Perfume oil | 0.5 | 0.5 | 0.5 | 0.5 |
| Water | Add | Add | Add | Add to 100 |
| | to 100 | to 100 | to 100 | |

a Neodol ®25-7 is C₁₂-C₁₅ alcohol ethoxylated with 7 moles of ethylene oxide as a nonionic surfactant, available from Shell
b Diethylene triamine penta methylene phosphonic acid as a chelant
c 3-(dodecylthio)-1-(2,6,6-trimethylcyclohexen-3-en-1-yl)-1-butanone, available from Firmenich
d Lupasol ® is polyethyleneimine (PEI) as an AAD, available from BASF

Preparation of the Compositions of Examples 1A-1D

The compositions of Examples 1A-1D are prepared by the following steps:
a) mixing a combination of NaOH, 1,2 propanediol, and water in a mixer by applying a shear of 200 rpm;
b) adding citric acid, C₁₁-C₁₃ LAS, NaOH, monoethanolamine, Neodol®25-7, and C₁₂-C₁₈ fatty acid in sequence into the combination obtained in step a), keeping on mixing by applying a shear of 200 rpm;
c) cooling down the temperature of the combination obtained in step b) to 25° C.;
d) adding ethanol into the combination obtained in step c);
e) adding C₁₂-C₁₄AE₁₋₃S and DTPMP into the combination obtained in step d), mixing by applying a shear of 250 rpm until the combination is homogeneously mixed, and adjusting pH to 8;
f) adding potassium sulfite, protease, amylase, the sulfur-containing pro-perfume compound, Lupasol® (if any), perfume microcapsule (if any), dye (if any), and perfume oil into the combination obtained in step e), keeping on mixing by applying a shear of 250 rpm for 5 minutes, thus forming a liquid laundry detergent composition,

wherein each ingredient in the composition is present in the amount as specified for Examples 1A-1D in Table 1.

### Examples 2A-2B

### Two-Compartment Pouches Comprising Formulations of Liquid Detergent Compositions

The compositions as shown in Table 2 are introduced into a pouch having two compartments. The compositions are made comprising the listed ingredients in the listed proportions (weight % measured by weight of the composition in the respective compartment, rather than by weight of the whole pouch). Both of the compositions contained in the 1^{st} compartment and the 2^{nd} compartment of Examples 2A-2B are in liquid forms, and for both Examples 2A and 2B, the required liquid detergent composition is contained in the 1^{st} compartment. The pouches of Examples 2A-2B have the same total compositional weight of 25.4 grams, in which the compositions contained in the 1^{st} compartment and 2^{nd} compartment weigh 3.4 grams and 22 grams, respectively. The film used is MonoSol M8639 film as supplied by MonoSol.

TABLE 2

| | |
|---|---|
| 1^{st} Compartment | 2^{nd} Compartment |

| | | |
|---|---|---|
| 2A | | |
| C₁₁-C₁₃LAS | 21 | 18 |
| C₁₂-C₁₄AE₁₋₃S | 10 | 9 |
| Surfonic ®L24-9 a | 17 | 16 |
| Citric acid | 0.7 | 0.7 |
| C₁₂-C₁₈ fatty acid | 7 | 6 |
| Na-DTPA b | 1 | 1 |
| 1,2 propanediol | 12 | 13 |
| Glycerol | 6 | 5 |
| Diethylene glycol | 0 | 2 |
| Monoethanolamine | 7 | 6 |
| Sodium hydrogen sulfite | 0.1 | 0.4 |
| Sulfur-containing pro-perfume c | 0.6 | 0 |
| Protease | 0 | 0.1 |
| Amylase | 0 | 0.01 |
| Lupasol ® d | 0 | 0.1 |
| Perfume microcapsule | 0.5 | 0 |
| Dye | 0.002 | 0.002 |
| Perfume oil | 0.5 | 0 |
| Water | Add to 100 | Add to 100 |
| 2B | | |
| C₁₁-C₁₃LAS | 21 | 18 |
| C₁₂-C₁₄AE₁₋₃S | 10 | 9 |
| Surfonic ®L24-9 a | 17 | 15 |
| Citric acid | 0.7 | 0.6 |
| C₁₂-C₁₈ fatty acid | 7 | 6 |
| Na-DTPA b | 1 | 1 |
| 1,2 propanediol | 12 | 13 |
| Glycerol | 6 | 5 |
| Diethylene glycol | 0 | 2 |
| Monoethanolamine | 7 | 6 |
| Sodium hydrogen sulfite | 0.1 | 0.4 |
| Sulfur-containing pro-perfume c | 0.6 | 0 |
| Protease | 0 | 0.1 |
| Amylase | 0 | 0.01 |
| Lupasol ® d | 0 | 0 |
| Perfume microcapsule | 0 | 0.5 |
| Dye | 0.002 | 0 |
| Perfume oil | 0.5 | 1 |
| Water | Add to 100 | Add to 100 |

a Surfonic ®L24-9 is C₁₂-C₁₄ alcohol ethoxylated with 9 moles of ethylene oxide as a nonionic surfactant, available from Huntsman
b penta sodium salt diethylene triamine penta acetic acid as a chelant
c 3-(dodecylthio)-1-(2,6,6-trimethylcyclohexen-3-en-1-yl)-1-butanone, available from Firmenich
d Lupasol ® is polyethyleneimine (PEI) as an AAD, available from BASF

Preparation of the Compositions of Examples 2A-2B

The pouches of Examples 2A-2B are prepared by the following steps:

1. Composition Preparation
a) Mixing a combination of Na-DTPA, 1, 2 propanediol, and water in a mixer by applying a shear of 200 rpm, and keeping the temperature of the combination under 45° C.;
b) adding monoethanolamine, Surfonic®, glycerol, sodium hydrogen sulfite, C₁₁-C₁₃ LAS, citric acid, C₁₂-C₁₈ fatty acid, and C₁₂-C₁₄AE₁₋₃S in sequence into the combination obtained in step a), keeping on mixing by applying a shear of 200 rpm, adjusting pH with monoethanolamine to 7.4;
c) adding diethylene glycol (if any), the sulfur-containing pro-perfume compound (if any), protease (if any), amylase (if any), perfume microcapsule (if any), dye (if any), and perfume oil (if any) into the combination obtained in step b), thus forming the required liquid laundry detergent composition that will be later contained in the 1^{st} compartment, wherein in the composition, each ingredient is present in the amount as specified for the 1^{st} compartment of Examples 2A-2B in Table 2; and
d) repeating above steps a), b), and c), and forming a 2^{nd} liquid laundry detergent composition that will be later contained in the 2^{nd} compartment, wherein in the composition, each ingredient is present in the amount as specified for the 2^{nd} compartment of Examples 2A-2B in Table 2.

2. Pouch Manufacturing
a) A first piece of MonoSol M8639 film is placed on top of a small mould and fixed in place. The small mould consists of a hemispherical shape and has a diameter of 33 mm and a depth of 14.5 mm. A 1 mm thick layer of rubber is present around the edges of the mould. The mould has some holes in the mould material to allow a vacuum to be applied to pull the film into the mould and pull the film flush with the inner surface of the mould. The required liquid laundry detergent composition obtained from above step 1c) is poured into the mould. A second piece of MonoSol M8639 film is placed over the top of the small mould with the required liquid laundry detergent composition and sealed to the first piece of film by applying a metal ring having an inner diameter of 34 mm and heating that metal under moderate pressure onto the ring of rubber at the edge of the mould to heat-seal the two pieces of film together to form a pre-sealed compartment comprising the required liquid laundry detergent (namely, the 1^{st} compartment). The metal ring is typically heated to a temperature of from 135° C. to 150° C. and applied for up to 5 seconds. The pre-sealed compartment has a 75 mm rim of the film which extends in an outwardly direction from the seal away from the centre of the pre-sealed compartment so that the pre-sealed compartment can be fixed into place and completely cover the opening of a mould with a larger diameter of 48.5 mm;
b) a third piece of MonoSol M8639 film is placed on top of a larger mould and fixed in place. The large mould consists of a cylindrical shape and has a diameter of 48.5 mm and a depth of 22 mm. A 1 mm thick layer of rubber is present around the edges of the mould. The mould has some holes in the mould material to allow a vacuum to be applied to pull the film into the large mould and pull the film flush with the inner surface of the mould. The 2^{nd} liquid laundry detergent composition obtained from above step 1d) is poured into the open compartment (namely, the 2^{nd} compartment);
c) the pre-sealed compartment is placed over the top of the large mould with the 2^{nd} liquid laundry detergent composition and fixed into place so that the pre-sealed compartment covers the opening of the large mould and the rim of film of the pre-sealed compartment is suitably placed over the layer of rubber which is present around the edges of the large mould so that the rim of film can form part of the seal which closes the open compartment; and
d) the rim of film of the pre-sealed compartment is sealed to the third piece of film by applying metal ring having an inner diameter of 50 mm and heating that metal under moderate pressure onto the ring of rubber at the edge of the mould to heat-seal the pieces of film together to form a pouch comprising two compartments, wherein the 1^{st} compartment comprises the required liquid laundry detergent composition and the 2^{nd} compartment comprises the 2^{nd} liquid laundry detergent composition. The metal ring is typically heated to a temperature of from 135° C. to 150° C. and applied for up to 5 seconds.

### Examples 3A-3B

### Three-Compartment Pouches Comprising Formulations of Liquid Detergent Compositions

The compositions as shown in Table 3 are introduced into a three-compartment pouch having a first compartment (the 1^{st} compartment) and two side-by-side compartments (the 2^{nd} compartment and 3^{rd} compartment) superposed onto the first compartment. The compositions are made comprising the listed ingredients in the listed proportions (weight % measured by weight of the composition in the respective compartment, rather than by weight of the whole pouch). All of the compositions contained in the 1^{st} compartment, 2^{nd} compartment, and 3^{rd} compartment of Examples 3A-3B are in liquid forms (hereinafter referred to as 1^{st} composition, 2^{nd} composition, and 3^{rd} composition, respectively). For Example 3A, the required liquid detergent composition is contained in the 2^{nd} compartment, while for Example 3B, the required liquid detergent composition is contained in the 1^{st} compartment. The pouches of Examples 3A-3B have the same total compositional weight of 25.4 grams, in which the composition contained in the 1^{st} compartment weighs 22 grams, and the compositions contained in the 2^{nd} and 3^{rd} compartments each weigh 1.7 grams. The film used is MonoSol M8639 film as supplied by MonoSol.

TABLE 3

| | | |
|---|---|---|
| 1^{st} | 2^{nd} | |
| Compartment | Compartment | 3^{rd} Compartment |

| | | | |
|---|---|---|---|
| 3A | | | |
| C₁₁-C₁₃LAS | 18 | 21 | 19 |
| C₁₂-C₁₄AE₁₋₃S | 9 | 10 | 9 |
| Surfonic ®L24-9 a | 15 | 16 | 17 |
| Citric acid | 0.6 | 0.7 | 0.7 |
| C₁₂-C₁₈ fatty acid | 6 | 7 | 6 |
| Na-DTPA b | 1 | 1 | 1 |
| 1,2 propanediol | 13 | 12 | 18 |
| Glycerol | 5 | 6 | 5 |
| Diethylene glycol | 2 | 0 | 0 |
| Monoethanolamine | 6 | 7 | 6 |
| Sodium hydrogen | 0.4 | 0.1 | 0.1 |
| sulfite | | | |
| Sulfur-containing | 0 | 1 | 0 |
| pro-perfume c | | | |
| Protease | 0.1 | 0 | 0 |
| Amylase | 0.01 | 0 | 0 |
| Dye | 0.002 | 0.002 | 0.002 |
| Perfume oil | 2 | 0.5 | 0 |
| Water | Add to 100 | Add to 100 | Add to 100 |
| 3B | | | |
| C₁₁-C₁₃LAS | 18 | 21 | 19 |
| C₁₂-C₁₄AE₁₋₃S | 9 | 10 | 9 |
| Surfonic ®L24-9 a | 15 | 17 | 17 |
| Citric acid | 0.6 | 0.7 | 0.7 |
| C₁₂-C₁₈ fatty acid | 6 | 7 | 6 |
| Na-DTPA b | 1 | 1 | 1 |
| 1,2 propanediol | 13 | 12 | 18 |
| Glycerol | 5 | 6 | 5 |
| Diethylene glycol | 2 | 0 | 0 |
| Monoethanolamine | 6 | 7 | 6 |
| Sodium hydrogen | 0.4 | 0.1 | 0.1 |
| sulfite | | | |
| Sulfur-containing | 0.1 | 0 | 0 |
| pro-perfume c | | | |
| Protease | 0.1 | 0 | 0 |
| Amylase | 0.01 | 0 | 0 |
| Dye | 0.002 | 0.002 | 0.002 |
| Perfume oil | 2 | 0.5 | 0 |
| Water | Add to 100 | Add to 100 | Add to 100 |

a Surfonic ®L24-9 is C₁₂-C₁₄ alcohol ethoxylated with 9 moles of ethylene oxide as a nonionic surfactant, available from Huntsman
b penta sodium salt diethylene triamine penta acetic acid as a chelant
c 3-(dodecylthio)-1-(2,6,6-trimethylcyclohexen-3-en-1-yl)-1-butanone, available from Firmenich

Preparation of the Compositions of Examples 3A-3B

The pouches of Examples 3A-3B are prepared by the following steps:

1. Composition Preparation

The compositions contained in the 1^{st} compartment, 2^{nd} compartment, and 3^{rd} compartment of Examples 3A-3B are prepared by the same steps as specified in step 1 of Examples 2A-2B, respectively, except for that each ingredient is present in the amount as specified for Examples 3A-3B in Table 3.

2. Pouch Manufacturing

a) A first compartment is made using a first pouch making unit that has a first forming surface, wherein the first forming surface is a horizontal moving forming surface comprising a plurality of single cavity moulds. A first piece of MonoSol M8639 film gets laid down on the first forming surface and drawn into the moulds by vacuum to form recesses which are subsequently filled with the 1^{st} composition obtained from above step 1. The 1^{st} compartment is thereby formed;

b) a second compartment is made using a second pouch making unit having a second forming surface, wherein the second forming surface is a circular rotating forming surface comprising a plurality of dual-cavity moulds. A second piece of MonoSol M8639 film gets laid down on the second forming surface and drawn into the dual-cavity moulds by vacuum. The 2^{nd} and 3^{rd} compositions obtained from above step 1 are dosed into the two different cavities to form a 2^{nd} and 3^{rd} compartments, at the top of the circular forming surface. A third piece of MonoSol M8639 film is wetted on a side, with the wetted side placed on top of the 2^{nd} and 3^{rd} compartments, thereby sealing to close the 2^{nd} and 3^{rd} compartments;

c) water is applied on the outer side of the third piece of film. When the 2^{nd} and 3^{rd} compartments reach the lowest point of the circular surface, they are brought into contact with the 1^{st} compartment and sealed due to pressure exerted by the first and second forming surfaces; and

d) the resulting pouches are cut to produce individual multi-compartment pouches.

### Comparative Examples 4A-4E

### Three-Compartment Pouches Comprising Comparative Formulations of Liquid Detergent Compositions

The comparative compositions as shown in Table 4 are introduced into a three-compartment pouch having a first compartment (the 1^{st} compartment) and two side-by-side compartments (the 2^{nd} compartment and 3^{rd} compartment) superposed onto the first compartment. The compositions are made comprising the listed ingredients in the listed proportions (weight % measured by weight of the composition in the respective compartment, rather than by weight of the whole pouch). All of the compositions contained in the 1^{st} compartment, 2^{nd} compartment, and 3^{rd} compartment of Comparative Examples 4A-4E are in liquid forms. The pouches of Comparative Examples 4A-4E have the same total compositional weight of 25 grams, in which the composition contained in the 1^{st} compartment weighs 22 grams, and the compositions contained in the 2^{nd} and 3^{rd} compartments each weigh 1.7 grams. The film used is MonoSol M8639 film as supplied by MonoSol.

TABLE 4

| | | 2^{nd} | 3^{rd} |
|---|---|---|---|
| | 1^{st} Compartment | Compartment | Compartment |
| 4A | | | |
| C₁₁-C₁₃LAS | 18 | 21 | 19 |
| C₁₂-C₁₄AE₁₋₃S | 9 | 10 | 9 |
| Surfonic ®L24-9 a | 15 | 17 | 17 |
| Citric Acid | 0.6 | 0.7 | 0.7 |
| C₁₂-C₁₈ fatty acid | 6 | 7 | 6 |
| Na-DTPA b | 1 | 1 | 1 |
| 1,2 propanediol | 13 | 12 | 18 |
| Glycerol | 5 | 6 | 5 |
| Diethylene glycol | 2 | 0 | 0 |
| Monoethanolamine | 6 | 7 | 6 |
| Sodium hydrogen | 0.4 | 0.1 | 0.1 |
| sulfite | | | |
| Protease | 0.1 | 0 | 0 |
| Amylase | 0.01 | 0 | 0 |
| N4-Amine c | 0 | 0 | 0 |
| Lupasol ® d | 0 | 0 | 0 |
| Delta-damascone | 0.05 | 0 | 0 |
| Dye | 0.002 | 0.002 | 0.002 |
| Perfume oil | 2 | 0.5 | 0 |
| Water | Add to 100 | Add to 100 | Add to 100 |
| 4B | | | |
| C₁₁-C₁₃LAS | 18 | 21 | 19 |
| C₁₂-C₁₄AE₁₋₃S | 9 | 10 | 9 |
| Surfonic ®L24-9 a | 15 | 17 | 17 |
| Citric Acid | 0.6 | 0.7 | 0.7 |
| C₁₂-C₁₈ fatty acid | 6 | 7 | 6 |
| Na-DTPA b | 1 | 1 | 1 |
| 1,2 propanediol | 13 | 12 | 18 |
| Glycerol | 5 | 6 | 5 |
| Diethylene glycol | 2 | 0 | 0 |
| Monoethanolamine | 6 | 7 | 6 |
| Sodium hydrogen | 0.4 | 0.1 | 0.1 |
| sulfite | | | |
| Protease | 0.1 | 0 | 0 |
| Amylase | 0.01 | 0 | 0 |
| N4-Amine c | 0 | 0 | 0 |
| Lupasol ® d | 0 | 0.6 | 0 |
| Delta-damascone | 0 | 0.6 | 0 |
| Dye | 0.002 | 0.002 | 0.002 |
| Perfume oil | 2 | 0.5 | 0 |
| Water | Add to 100 | Add to 100 | Add to 100 |
| 4C | | | |
| C₁₁-C₁₃LAS | 18 | 21 | 19 |
| C₁₂-C₁₄AE₁₋₃S | 9 | 10 | 9 |
| Surfonic ®L24-9 a | 15 | 17 | 17 |
| Citric Acid | 0.6 | 0.7 | 0.7 |
| C₁₂-C₁₈ fatty acid | 6 | 7 | 6 |
| Na-DTPA b | 1 | 1 | 1 |
| 1,2 propanediol | 13 | 12 | 18 |
| Glycerol | 5 | 6 | 5 |
| Diethylene glycol | 2 | 0 | 0 |
| Monoethanolamine | 6 | 7 | 6 |
| Sodium hydrogen | 0.4 | 0.1 | 0.1 |
| sulfite | | | |
| Protease | 0.1 | 0 | 0 |
| Amylase | 0.01 | 0 | 0 |
| N4-Amine c | 0 | 0.6 | 0 |
| Lupasol ® d | 0 | 0 | 0 |
| Delta-damascone | 0 | 0.6 | 0 |
| Dye | 0.002 | 0.002 | 0.002 |
| Perfume oil | 2 | 0.5 | 0 |
| Water | Add to 100 | Add to 100 | Add to 100 |
| 4D | | | |
| C₁₁-C₁₃LAS | 18 | 21 | 19 |
| C₁₂-C₁₄AE₁₋₃S | 9 | 10 | 9 |
| Surfonic ®L24-9 a | 15 | 17 | 17 |
| Citric Acid | 0.6 | 0.7 | 0.7 |
| C₁₂-C₁₈ fatty acid | 6 | 7 | 6 |
| Na-DTPA b | 1 | 1 | 1 |
| 1,2 propanediol | 13 | 12 | 18 |
| Glycerol | 5 | 6 | 5 |
| Diethylene glycol | 2 | 0 | 0 |
| Monoethanolamine | 6 | 7 | 6 |
| Sodium hydrogen | 0.4 | 0.1 | 0.1 |
| sulfite | | | |
| Protease | 0.1 | 0 | 0 |
| Amylase | 0.01 | 0 | 0 |
| N4-Amine c | 0.05 | 0 | 0 |
| Lupasol ® d | 0 | 0 | 0 |
| Delta-damascone | 0 | 0.6 | 0 |
| Dye | 0.002 | 0.002 | 0.002 |
| Perfume oil | 2 | 0.5 | 0 |
| Water | Add to 100 | Add to 100 | Add to 100 |
| 4E | | | |
| C11-C13LAS | 18 | 21 | 19 |
| C12-C14AE1-3S | 9 | 10 | 9 |
| Surfonic ®L24-9 a | 15 | 17 | 17 |
| Citric Acid | 0.6 | 0.7 | 0.7 |
| C12-C18 fatty acid | 6 | 7 | 6 |
| Na-DTPA b | 1 | 1 | 1 |
| 1,2 propanediol | 13 | 12 | 18 |
| Glycerol | 5 | 6 | 5 |
| Diethylene glycol | 2 | 0 | 0 |
| Monoethanolamine | 6 | 7 | 6 |
| Sodium hydrogen | 0.4 | 0.1 | 0.1 |
| sulfite | | | |
| Protease | 0.1 | 0 | 0 |
| Amylase | 0.01 | 0 | 0 |
| N4-Amine c | 0 | 0.6 | 0 |
| Lupasol ® d | 0 | 0 | 0 |
| Delta-damascone | 0 | 0.6 | 0 |
| Dye | 0.002 | 0.002 | 0.002 |
| Perfume oil | 2 | 0.5 | 0 |
| Water | Add to 100 | Add to 100 | Add to 100 |

a Surfonic ®L24-9 is C₁₂-C₁₄ alcohol ethoxylated with 9 moles of ethylene oxide as a nonionic surfactant, available from Huntsman
b penta sodium salt diethylene triamine penta acetic acid as a chelant
c N4-Amine is N,N′-Bis-(3-Aminopropyl)ethylene-diamine as an AAD, available from BASF
d Lupasol ® is polyethyleneimine (PEI) as an AAD, available from BASF

Preparation of the Compositions of Comparative Examples 4A-4E

The pouches of Comparative Examples 4A-4E are prepared by the same steps as in Examples 3A-3B, except for the following: N4-Amine (if any), Lupasol® (if any), and Delta-damascone are added in step 1c), and each ingredient is present in the amount as specified for Examples 4A-4E in Table 4.

Comparative Data of Examples 3 and 4 on Odor Performance

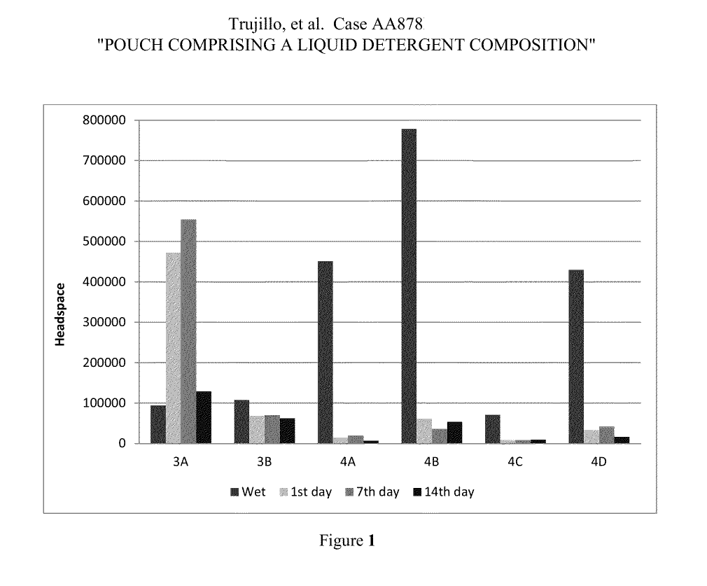

Comparative experiments of measuring the odor performance of the pouches of Examples 3A-3B and Comparative Examples 4A-4D are conducted, according to the method for determining of odor performance for detergent compositions as described herein above. The olfactory grading data tested at the wet stage (WFO) and dry stage on the 7^{th} day and 14^{th} day (DFO on the 7^{th} day and DFO on the 14^{th} day) is shown in Table 5, and the headspace data tested at the wet stage and at the dry stage on the 1^{st} day, 7^{th} day, and 14^{th} day is shown in FIG. 1.

TABLE 5

| | WFO | DFO on the 7^{th} day | DFO on the 14^{th} day |
|---|---|---|---|
| 3A | 72.5 | 30 | 30 |
| 3B | 70 | 27.5 | 27.5 |
| 4A | 75 | 25 | 25 |
| 4B | 65 | 25 | 27.5 |
| 4C | 65 | 25 | 27.5 |
| 4D | 67.5 | 27.5 | 27.5 |

As shown from Table 5 and FIG. 1, the pouches comprising compositions according to the present invention (Examples 3A-3B) demonstrate good odor performances (i.e., a significantly long lasting scent). By contrast, none of the pouches comprising comparative compositions (Comparative Examples 4A-4D) show a comparable odor performance in terms of olfactory grading data and headspace data.

Moreover, when the required liquid detergent composition is present in one of the two side-by-side compartments (Example 3A), the best odor performance is achieved. Without wishing to be bound by theory, this might be due to the reason that the two side-by-side compartments (namely, the 2^{nd} compartment and 3^{rd} compartment) dissolve later than the 1^{st} compartment during a wash cycle, which enables longer time of the sulfur-containing pro-perfume compound being held in the 1^{st} compartment, and therefore less amounts of the compound being adversely affected by certain ingredients contained in and release from another compartment.

Comparative Data of Examples 3 and 4 on Color Stability

Comparative experiments of measuring the color stability of the compositions in the 2^{nd} compartment of 3A, 2^{nd} compartment of 4B, and 2^{nd} compartment of 4E are conducted, according to the method for determining of color stability for detergent compositions as described herein above. The values of ΔL, Δa, Δb, and ΔE are shown in Table 6.

TABLE 6

| | 3A | | |
|---|---|---|---|
| | 2^{nd} | 4B | 4E |
| | Compartment | 2^{nd} Compartment | 2^{nd} Compartment |
| ΔE | 1.53 | 21.70 | 10.47 |
| ΔL | 0.23 | −4.32 | −2.11 |
| Δa | −0.71 | −4.85 | −2.22 |
| Δb | 1.34 | 20.70 | 10.01 |

As shown in Table 6, the liquid detergent composition according to the present invention (the composition in the 2^{nd} compartment of Example 3A) demonstrates a good color stability profile, whereas the comparative compositions (the compositions in the 2^{nd} compartment of Comparative Examples 4B and 2^{nd} compartment of Comparative Example 4E) experience significant color changes.

Unless otherwise indicated, all percentages, ratios, and proportions are calculated based on weight of the total composition. All temperatures are in degrees Celsius (° C.) unless otherwise indicated. All measurements made are at 25° C., unless otherwise designated. All component or composition levels are in reference to the active level of that component or composition, and are exclusive of impurities, for example, residual solvents or by-products, which may be present in commercially available sources.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A pouch, comprising a water-soluble film and a liquid detergent composition contained within said water-soluble film, wherein the composition comprises:
a) an alkanolamine;
b) a sulfite;
c) a perfume oil comprising aldehyde or ketone; and
d) a sulfur-containing pro-perfume compound.

2. The pouch according to claim 1, wherein said sulfur-containing pro-perfume compound comprises a compound of formula (I):
Y—S-G-Q (I)
wherein:
(i) Y is a radical selected from the group consisting of (Y-1) to (Y-7) shown herein below, including isomeric forms: 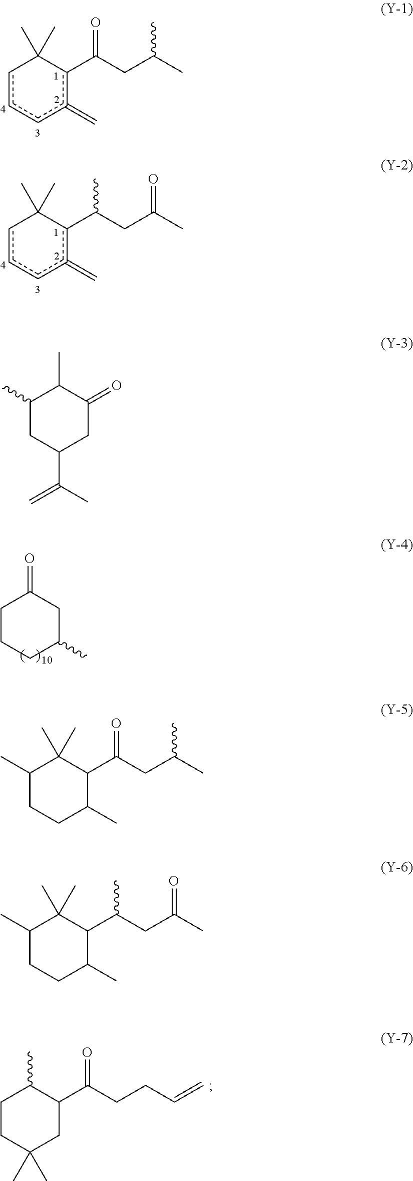
wherein the wavy lines represent the location of the sulfur bond, and the dotted lines represent a single or double bond;
(ii) G is selected from a divalent or trivalent radical derived from a linear or branched alkyl or alkenyl radical having from 2 to 15 carbon atoms; and
(iii) Q is selected from a hydrogen, a —S—Y group, or a —NR²—Y group, wherein Y is independently selected as defined above, and R² is selected from a hydrogen or a C₁-C₃ alkyl group.

3. The pouch according to claim 2, wherein G is a divalent radical derived from a linear or branched alkyl or alkenyl radical having from 2 to 15 carbon atoms, substituted with one or more groups selected from the group consisting of —OR¹, —NR¹₂, —COOR¹, R¹ groups, and a combination thereof, wherein R¹ is selected from a hydrogen atom or a C₁ to C₆ alkyl or alkenyl group.

4. The pouch according to claim 2, wherein G is selected from either a divalent radical derived from a linear alkyl radical having from 8 to 15 carbon atoms or a —CH₂CH(COOR¹) group, wherein R¹ is a hydrogen or a methyl or ethyl group.

5. The pouch according to claim 2, wherein Y is selected from Y-1, Y-2 or Y-3 groups.

6. The pouch according to claim 2, wherein said sulfur-containing pro-perfume compound is selected from the group consisting of methyl or ethyl 2-(4-oxo-4-(2,6,6-trimethylcyclohex-3-en-1-yl)butan-2-ylamino)-3-(4-oxo-4-(2,6,6-trimethylcyclohex-3-en-1-yl)butan-2-ylthio)propanate, methyl or ethyl 2-(4-oxo-4-(2,6,6-trimethylcyclohex-2-en-1-yl)butan-2-ylamino)-3-(4-oxo-4-(2,6,6-trimethylcyclohex-2-en-1-yl)butan-2-ylthio)propanate, methyl or ethyl 2-(2-oxo-4-(2,6,6-trimethylcyclohex-1-en-1-yl)butan-4-ylamino)-3-(2-oxo-4-(2,6,6-trimethylcyclohex-1-en-1-yl)butan-4-ylthio)propanate, methyl or ethyl 2-(2-oxo-4-(2,6,6-trimethylcyclohex-2-en-1-yl)butan-4-ylamino)-3-(2-oxo-4-(2,6,6-trimethylcyclohex-2-en-1-yl)butan-4-ylthio)propanate, 3-(dodecylthio)-1-(2,6,6-trimethylcyclohex-3-en-1-yl)-1-butanone, 3-(dodecylthio)-1-(2,6,6-trimethylcyclohex-2-en-1-yl)-1-butanone, 4-(dodecylthio)-4-(2,6,6-trimethylcyclohex-2-en-1-yl)-2-butanone, 4-(dodecylthio)-4-(2,6,6-trimethylcyclohex-1-en-1-yl)-2-butanone, 2-dodecylsulfanyl-5-methyl-heptan-4-one, 2-cyclohexyl-1-dodecylsulfanyl-hept-6-en-3-one, 3-(dodecylthio)-5-isopropenyl-2-methylcyclohexanone, and a combination thereof.

7. The pouch according to claim 6, wherein said sulfur-containing pro-perfume compound is selected from the group consisting of 3-(dodecylthio)-1-(2,6,6-trimethylcyclohex-3-en-1-yl)-1-butanone, 4-(dodecylthio)-4-(2,6,6-trimethylcyclohex-2-enl-yl)-2-butanone, 4-(dodecylthio)-4-(2,6,6-trimethylcyclohex-1-en-1-yl)-2-butanone, 3-(dodecylthio)-5-isopropenyl-2-methylcyclohexanone, and a combination thereof, and preferably is 3-(dodecylthio)-5-isopropenyl-2-methylcyclohexanone.

8. The pouch according to claim 1, wherein said alkanolamine is selected from the group consisting of methanolamine, ethanolamine, propaneolamine, and a combination thereof.

9. The pouch according to claim 1, wherein said sulfite is selected from the group consisting of sodium hydrogen sulfite, sodium sulfite, potassium hydrogen sulfite, potassium sulfite, and a combination thereof.

10. The pouch according to claim 1, wherein said perfume oil comprising aldehyde or ketone is a perfume oil comprising ketone, and said perfume comprising ketone comprises a Perfume Raw Material (PRM) selected from the group consisting of alpha-damascone, delta-damascone, iso-damascone, carvone, gamma-methyl-ionone, beta-ionone, iso-e-super, 2,4,4,7-tetramethyl-oct-6-en-3-one, benzyl acetone, beta-damascone, damascenone, methyl dihydrojasmonate, methyl cedrylone, hedione, floralozone, and a combination thereof.

11. The pouch according to claim 1, wherein:
said alkanolamine is present from about 0.5% to about 7%, by weight of the composition;
said sulfite is present from about 0.05% to about 1%, by weight of the composition;
said perfume oil comprising aldehyde or ketone is present from about 0.1% to 3%, by weight of the composition; and
said sulfur-containing pro-perfume compound is present from about 0.01% to about 3%, by weight of the composition.

12. The pouch according to claim 11, wherein said sulfite is present from about 0.1% to about 0.4%, by weight of the composition.

13. The pouch according to claim 11, further comprising from about 3% to about 21%, by weight of the composition, of a linear alkylbenzene sulfonate (LAS).

14. The pouch according to claim 1, comprising less than 0.01%, by weight of the composition, of an amine assisted delivery system (AAD).

15. The pouch according to claim 1, wherein the composition further comprises a perfume microcapsule (PMC).

16. The pouch according to claim 1, wherein the composition has a pH of from about 7 to 9.

17. The pouch according to claim 1, wherein said water-soluble film is polyvinyl alcohol.

18. The pouch according to claim 17, comprising multiple compartments, wherein the composition is contained in one compartment of said multiple compartments.

19. The pouch according to claim 18, comprising two compartments, wherein said two compartments comprise a first compartment and a second compartment, wherein the composition is contained in said first compartment and a second composition is contained in said second compartment, and wherein said second composition comprises an amine-assisted delivery system (AAD).

20. The pouch according to claim 18, comprising three compartments, wherein said three compartments comprise a first compartment, a second compartment, and a third compartment, wherein said first compartment and said second compartment are placed side-by-side and superposed onto said third compartment, and wherein the composition is contained in said first compartment or said second compartment.
